(19) United States
(12) Patent Application Publication
(10) Pub. No.: US 2006/0246978 A1
(43) Pub. Date: Nov. 2, 2006

(54) Extended play for poker-style card games

(76) Inventor: Bryan Gallagher, Gibsonia, PA (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/120,213

(22) Filed: May 2, 2005

(51) Int. Cl. A63F 13/00

(52) U.S. Cl. 463/13

(57) ABSTRACT

Various embodiments of a method for playing a card game in association with a poker-style card game are disclosed. The method may include playing the poker-style card game to a normal ending point; permitting placement of a supplemental bet in association with the poker-style card game; dealing at least one additional card at a normal ending point of the poker-style card game in response to placement of the supplemental bet; and, factoring the additional card into the outcome of the poker-style card game.

### BACKGROUND

It has been said that the two greatest sources of excitement involved in playing a poker-style card game are winning and losing. For most conventional card games, the drama surrounding these events climaxes at a normal ending point of the card game.

For many players, the anticipation and excitement of the culmination of play for a card game often ends too soon, particularly if the player barely misses achieving a superior hand in the game. Conventional poker-style card games do not allow for the kind of extended play that would offer the opportunity for players to improve hands that are less than satisfactory at the end of normal play. Furthermore, casino operators and other sponsors of card games have historically and unknowingly incurred substantial opportunity costs associated with not extending the play of poker-style card games. These opportunity costs are embodied as lost bet revenue from players who may want to extend play to attempt to improve the results of their hands, but who are not offered the chance to do so.

In general, conventional card games do not leverage the drama and excitement that arises at the normal ending point of the card game which can enhance player enjoyment and potentially increase financial returns for players and casino operators. In view of these deficiencies, improved card games are needed that will enhance player enjoyment while creating additional opportunities for financial returns.

### SUMMARY

The present invention provides a method for playing a card game in association with a poker-style card game. Embodiments of the method may include playing the poker-style card game to a normal ending point; permitting placement of a supplemental bet in association with the poker-style card game; dealing at least one additional card at a normal ending point of the poker-style card game in response to placement of the supplemental bet; and, factoring the additional card into the outcome of the poker-style card game.

In addition, various computer-readable media and system embodiments are provided in association with card games of the present invention.

### BRIEF DESCRIPTION OF THE FIGURES

The utility of the embodiments of the invention will be readily appreciated and understood from consideration of the following description of the embodiments of the invention when viewed in connection with the accompanying drawings.

FIG. 1 includes a process flow diagram illustrating embodiments of a card game provided in accordance with embodiments of the present invention;

FIG. 2 includes a system architecture that may be configured for playing a card game in accordance with embodiments of the present invention;

FIGS. 3A through 3D include schematic diagrams illustrating various aspects of a sample poker-style card game that may be played in association with embodiments of the present invention;

FIG. 4 includes a table illustrating a sample payout schedule that may be provided in accordance with embodiments of the present invention;

FIGS. 5A through 5K include schematic diagrams illustrating various aspects of a sample poker-style card game that may be played in association with embodiments of the present invention;

FIGS. 6A and 6B include schematic diagrams illustrating various aspects of a sample poker-style card game that may be played in association with embodiments of the present invention;

FIGS. 7A and 7B include schematic diagrams illustrating various aspects of a sample poker-style card game that may be played in association with embodiments of the present invention; and,

FIGS. 8A through 8D include schematic diagrams illustrating various aspects of a sample poker-style card game that may be played in association with embodiments of the present invention.

### DESCRIPTION

As applied herein, the term “poker-style card game” may include any card game to which embodiments of the present invention can be suitably applied, or which can be readily configured or modified for application of the present invention. Examples of “poker-style card games” include, without limitation, draw poker games (e.g., five-card draw), stud poker games (e.g., five-card stud, seven-card stud), Texas Hold 'Em poker, “Caribbean draw” poker, “Caribbean stud” poker, “Let It Ride” poker, “Triple Play” poker, Pai Gow poker, “three card” poker, “four card” poker, and a variety of other card games.

The term “card” may include any card in electronic or non-electronic format that can be suitably employed during play of a poker-style card game. A “card” may also include any other piece, element or other instrument used in conjunction with play of a poker-style card game. Suits of cards illustrated herein may at times be designated as “c” (for clubs), “d” (for diamonds), “h” (for hearts), or “s” (for spades). For example, the notation “Kd” applied to a card means the card is a king of diamonds. In certain embodiments, the poker-style card games described herein may be played with one or more standard 52-card decks of cards; in other embodiments, a non-standard deck of cards (e.g., a standard 52-card deck of cards plus two jokers) may be used in connection with playing a poker-style card game.

As applied herein, a “supplemental bet” may be any payment, consideration or other commitment or sacrifice made to receive one or more additional cards in accordance with embodiments of the present invention described herein. A “supplemental bet” may be embodied, for example and without limitation, as an extra bet, as a portion of another bet (e.g., an initial wager placed to play a poker-style card game), or as a sacrifice of a bet or a portion of a bet previously wagered. In certain embodiments, a supplemental bet may not be required to receive an additional card or cards, i.e., the amount of the supplemental bet may be effectively zero.

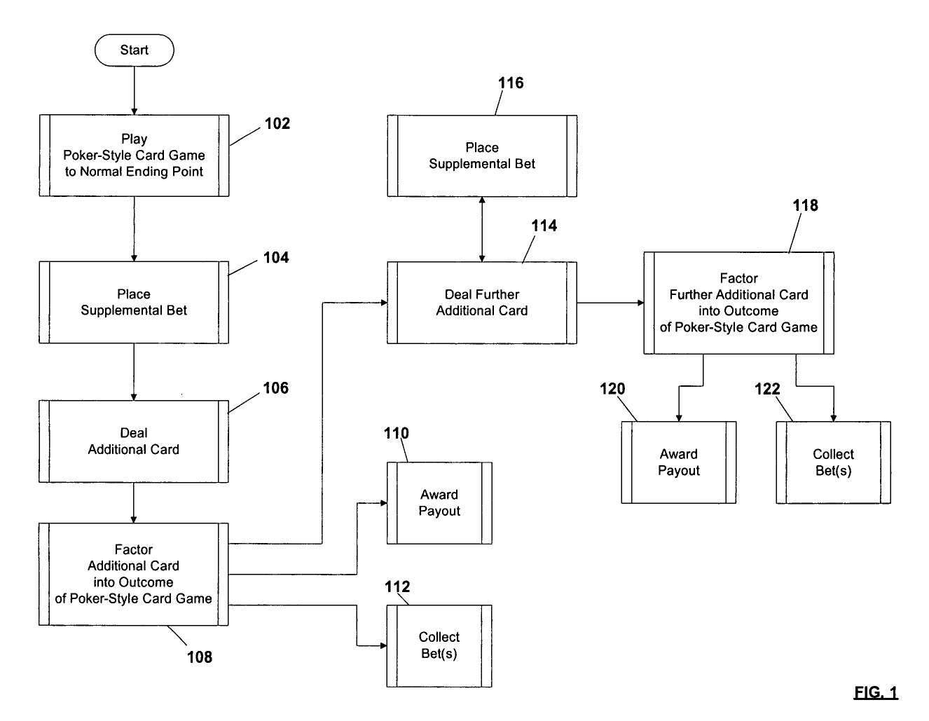

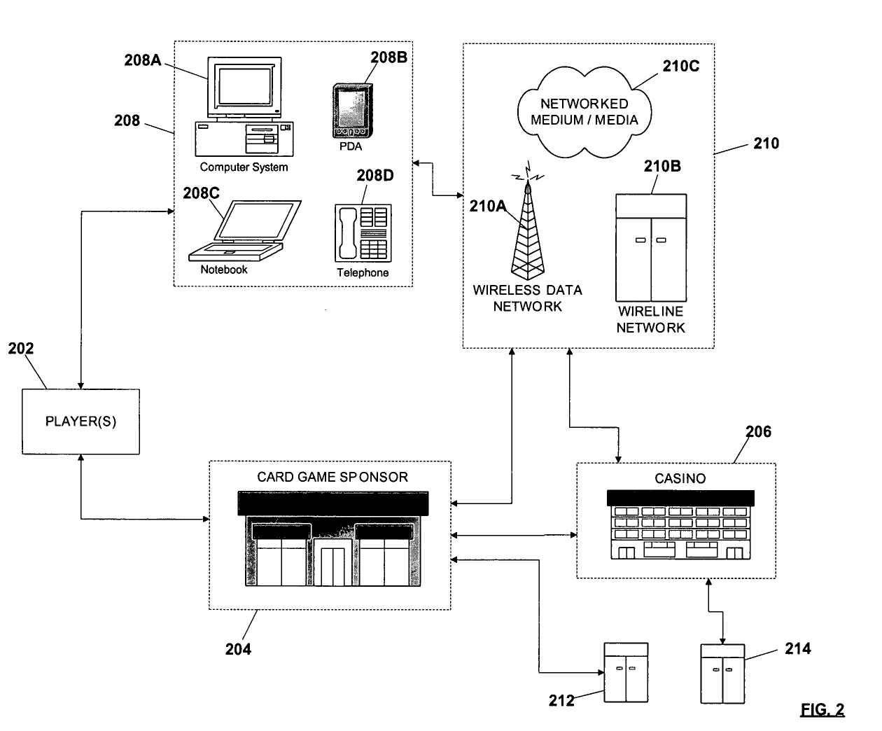

Referring now to FIG. 1, a process flow diagram illustrates various embodiments of a method of playing a card game in accordance with the present invention. At step 102, a poker-style card game is played to a normal ending point by one or more players of the poker-style card game. A “normal ending point” for a poker-style card game may occur, for example, when a winner is declared, when a payout is made to a player, and/or when at least one bet is collected from a player, in accordance with the outcome of the poker-style card game.

At step 104, one or more players may place a supplemental bet in association with the poker-style card game. The supplemental bet may be placed, for example, if the player is not satisfied with the outcome produced at the normal ending point of the poker-style card game; if the player wants to attempt to improve the hand dealt during play of the poker-style card game through the normal ending point; or, if the player otherwise wants to extend play of the poker-style card game beyond the normal ending point of the poker-style card game.

In certain embodiments of the invention, the supplemental bet may be placed by the player at any time prior to or during play of the poker-style card game up to the normal ending point of the poker-style card game. The supplemental bet may also be placed after or in conjunction with the normal ending point of the poker-style card game. In certain embodiments, the supplemental bet may include an extra bet, a portion of another bet (e.g., an initial wager placed to play a poker-style card game), or as a sacrifice of a bet or a portion of a bet previously wagered. In certain embodiments, a supplemental bet may not be required to receive an additional card or cards, i.e., the amount of the supplemental bet may be effectively zero. Those skilled in the art will appreciate that the amount of the supplemental bet, or a payout derived from the supplemental bet, may be governed by various factors. For example, one factor may be the effect of dealing the additional card on the probability that the player may improve the hand dealt during play of the poker-style card game through its normal ending point.

At step 106, at least one additional card may be dealt to one or more players in response to placement of the supplemental bet by each player. In many embodiments, the additional card may be dealt from the same deck of cards from which other cards are dealt during the game; or, the additional card may be dealt from a deck of only face cards, for example, or from another deck of cards which may be independent of the deck used to deal cards during normal play of the card game. At step 108, the additional card may be factored into the outcome of the poker-style card game. For example, in applying embodiments of the present invention to five-card draw played on a video gaming machine, the player may be one card away from achieving a flush in a given suit. In this example, the player places the supplemental bet in accordance with step 104, and the impact of the additional card dealt to the player (at step 106) may be determined at step 108. The additional card may yield, for example, a card of the suit needed by the player to achieve the flush and its associated payout.

At step 110, depending on the impact of the additional card on the outcome of the poker-style card game, at least one payout may be awarded to one or more players. At step 112, depending on the impact of the additional card on the outcome of the poker-style card game, at least one bet may be collected from one or more players. In various embodiments, payouts may be awarded and/or bets may be collected, for example, by a video gaming machine, a casino operator, a sponsor of a table game, or another entity directing the play of the card game. It can be appreciated that payouts may be awarded and/or bets may be collected in connection with one or both of: (1) playing the poker-style card game through its normal ending point; and, (2) factoring the additional card into the outcome of the poker-style game.

At step 114, in certain embodiments of the invention, at least one further additional card may be dealt. As described above, the further additional card may be dealt in response to or in association with a supplemental bet placed at step 116, as shown. In many embodiments, the further additional card may be dealt from the same deck of cards from which other cards are dealt during the game; or, the further additional card may be dealt from a deck of only face cards, for example, or from another deck of cards which may be independent of the deck used to deal cards during normal play of the card game. At step 118, the further additional card may be factored into the outcome of the poker-style card game in substantial accordance with step 108 (described above). At step 120, depending on the impact of the further additional card on the outcome of the poker-style card game, at least one payout may be awarded to one or more players. At step 122, depending on the impact of the further additional card on the outcome of the poker-style card game, at least one bet may be collected from one or more players. It can be appreciated that steps 114 through 122 may be performed and repeated as may be dictated or desired by players, casinos, or other card game sponsors to extend play of the poker-style game with further additional cards.

In certain embodiments of the invention, in addition to offering payouts for hands achieved by consideration of various five-card combinations, payouts may also be awarded for “premium” hands that combine six or more cards. Examples of premium six-card hand combinations that may receive payouts include six-card straights and flushes, six-card straight flushes, four-of-a-kind and a pair, two threes-of-a-kind, and three pair. Also, if wild cards or jokers are used in the card game, other premium hands such as six-of-a-kind may be achieved and receive appropriate payouts. It can be appreciated that in card games of the present invention in which more than six cards are used to make a hand, further premium hands that are achieved may be awarded (e.g., seven-card straight, seven-card flush, and so on). Given the relatively low probability of achieving a premium five-card hand, and the low probability of turning a premium five-card hand into a premium six-card hand (particularly for straight flushes, for example), the payout for a six-card straight flush or a nine-ace royal flush, for example, could be made substantial. It can be seen that the possibility of such a substantial payout in a card game will be an incentive to many players to place additional or supplemental bets.

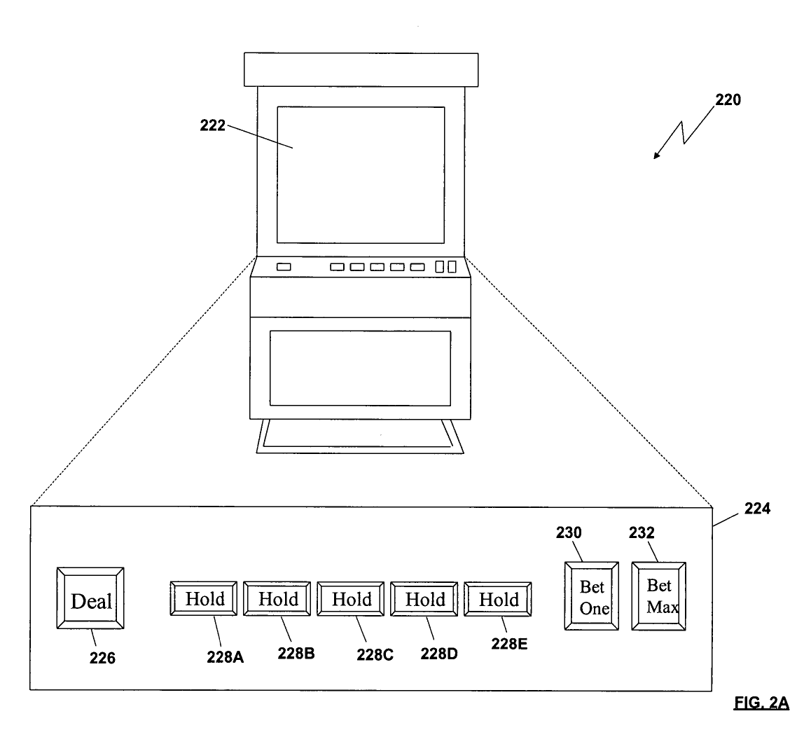

With reference to FIGS. 2 and 2A, to play or conduct various card game embodiments described herein, one or more players 202 may communicate with a card game sponsor 204 or a casino 206 using one or more different types of access devices 208 through various communication media 210. Examples of access devices 208 may include, without limitation, a computer system 208A, a personal digital assistant 208B, a notebook 208C, and a wireless telephone 208D. The access devices 208 may be configured with suitable software, hardware, or other computer-readable media that permit the players 202 to play a variety of card games.

One example of the computer system 208A is a video gaming machine 220 (as shown in FIG. 2A) that may be located in a casino, a bar, an entertainment service provider, and/or any other place where card games may be played or legal gambling may be conducted. The video gaming machine 220 may include a monitor 222 for viewing card game play and a console 224 that includes multiple buttons (226, 228A-228E, 230, 232) for manipulating cards or placing bets, for example, among other functions. In certain embodiments, the video gaming machine 220 may be configured for standalone operation or may be configured to interact with one or more of the communication media 210.

Examples of the communication media 210 may include, without limitation, a wireless data network 210A, a wireline network 210B, a networked medium or media 210C, or any other medium suitable for interfacing with and/or receiving data communicated from the access devices 208. For example, a personal computer 208A of the player 202 may be configured or programmed with instructions to receive, communicate or process card game data in association with accessing a web site of the casino 206 through a wireless Internet connection 210A.

In various embodiments of the invention, one or more computer systems 212, 214 may be used by the card game sponsor 204 and/or the casino 206 to maintain accounting records, for example, and/or to issue reports associated with the management of various card games played in accordance with the embodiments described herein. For example, the computer systems 212, 214 may include one or more databases that maintain data for card game play including, for example, player names, balance due, payouts awarded, bet amounts collected, amounts that players may gamble on credit, and/or other data. Periodic or non-periodic reports of data associated with card games played may be generated, distributed, or processed in electronic or non-electronic format by the card game sponsor 204, the casino 206, and/or other parties.

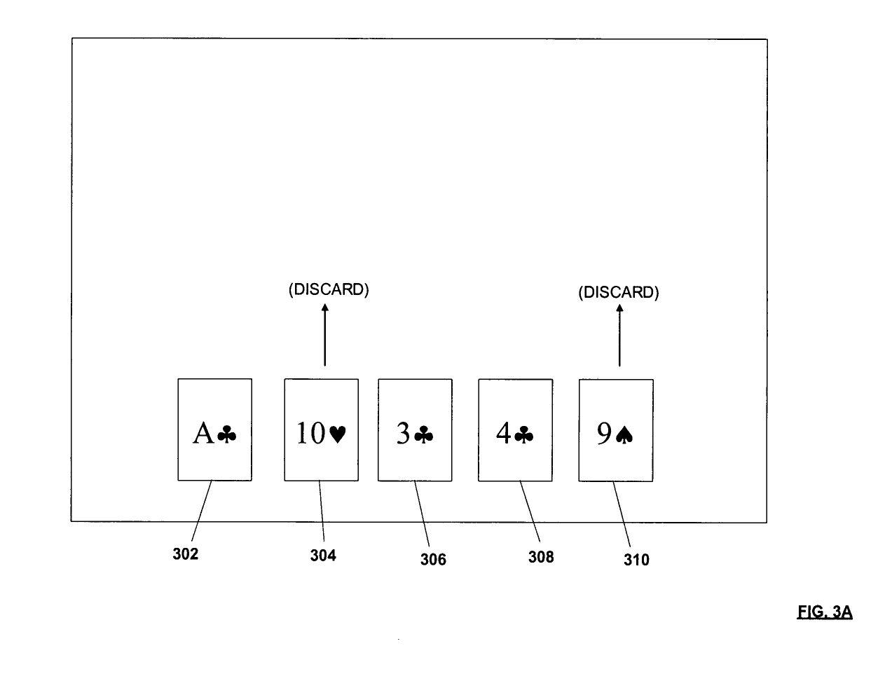

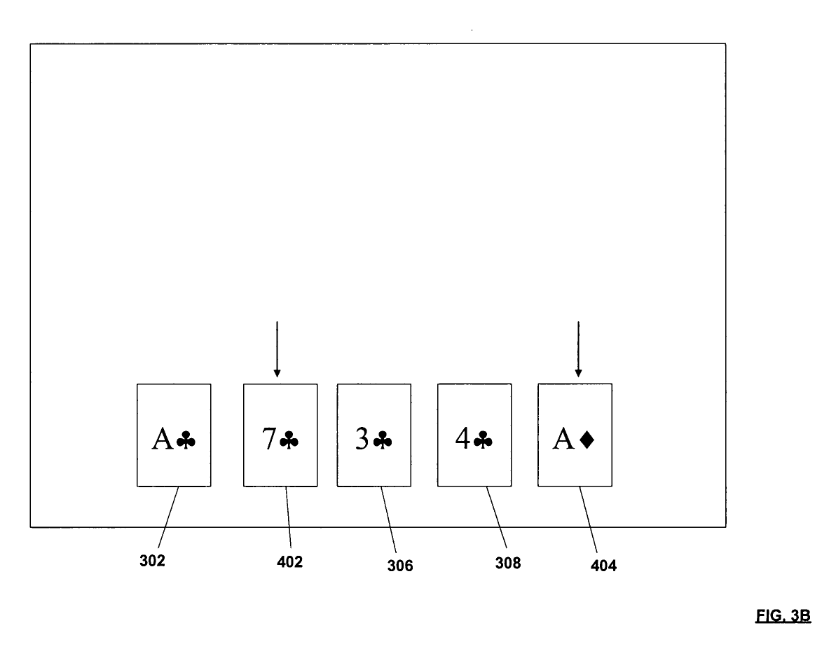

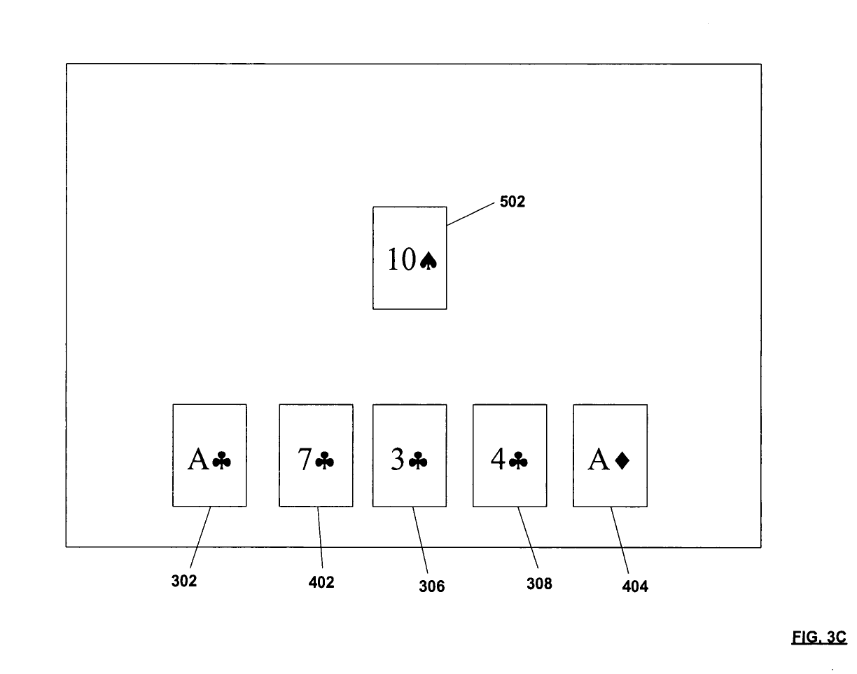

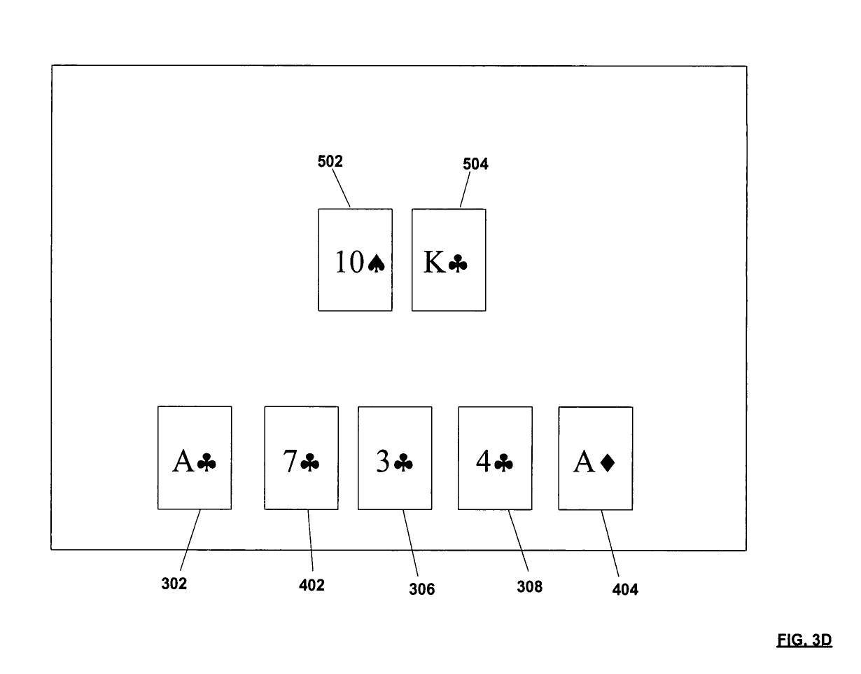

FIGS. 3A through 3C illustrate an example of how a poker-style card game (i.e., five-card draw) may be played on a video poker machine in accordance with embodiments of the present invention. The player deposits an appropriate amount of coins or tokens as an initial bet and then receives five cards as shown in FIG. 3A: an ace (clubs) 302, a ten (hearts) 304, a three (clubs) 306, a four (clubs) 308, and a nine (spades) 310. The player then chooses to discard the ten (hearts) 304 and the nine (spades) 310, and receives a seven (clubs) 402 and an ace (diamonds) 404 as shown in FIG. 3B. It can be seen that the player now has a pair of aces 302, 404, which will result in a payout to the player should the player elect to end the game at this point. Instead of ending the game, however, the player places a supplemental bet to receive an additional card 502 (as shown in FIG. 3C) in an attempt to achieve a flush hand (with clubs). Unfortunately for the player, the additional card 502 is a ten (spades) which does not improve the hand as it existed at the normal ending point of the card game. The player may nonetheless receive a payout for the pair of aces 302, 404, but by placing the supplemental bet the player does not realize the same value as if the game had been stopped at its normal ending point. In another variation of this example, assuming the player had made the flush (with clubs), a total payout could have included one or both of the payouts associated with the pair of aces 302, 404 and the flush.

In addition, the play of the sample card game described in association with FIGS. 3A-3C may be extended by dealing a further additional card 504, as shown in FIG. 3D. In this example, the player places another supplemental bet to have the further additional card 504 dealt, which is a king (clubs). The player has now achieved a flush (clubs) by factoring the further additional card 504 into the hand, and the player is awarded the payout associated with the flush.

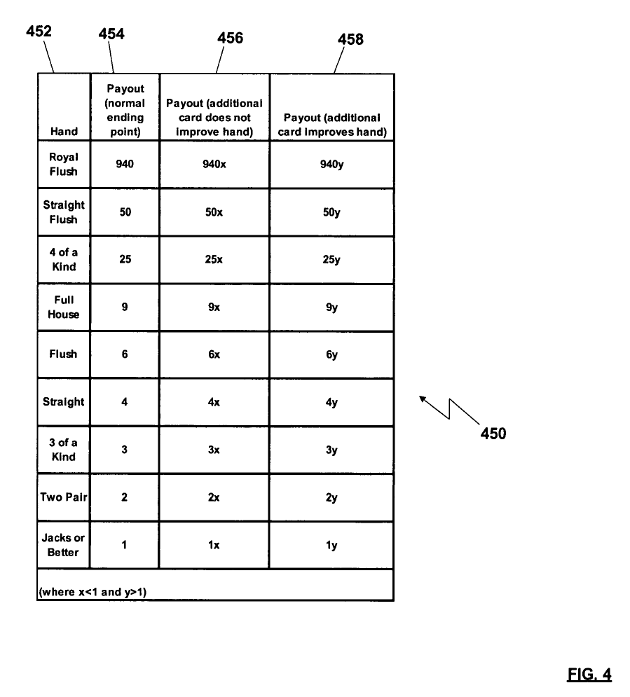

With reference to FIG. 4, a table 450 illustrates sample payout schedules for various hands that may be achieved in accordance with a five-card draw poker game played in accordance with embodiments of the present invention. For each hand in column 452 that may be achieved while playing a poker-style card game, there is shown a conventional payout at the normal ending point of the poker-style card game (column 454); a payout if an additional card does not improve the hand (column 456); and a payout if the additional card improves the hand (column 458).

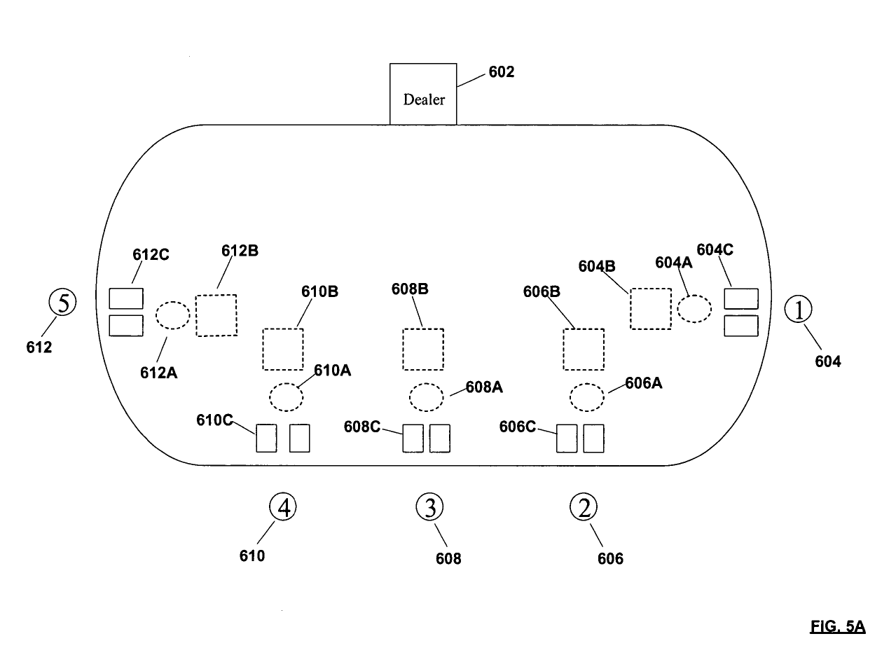

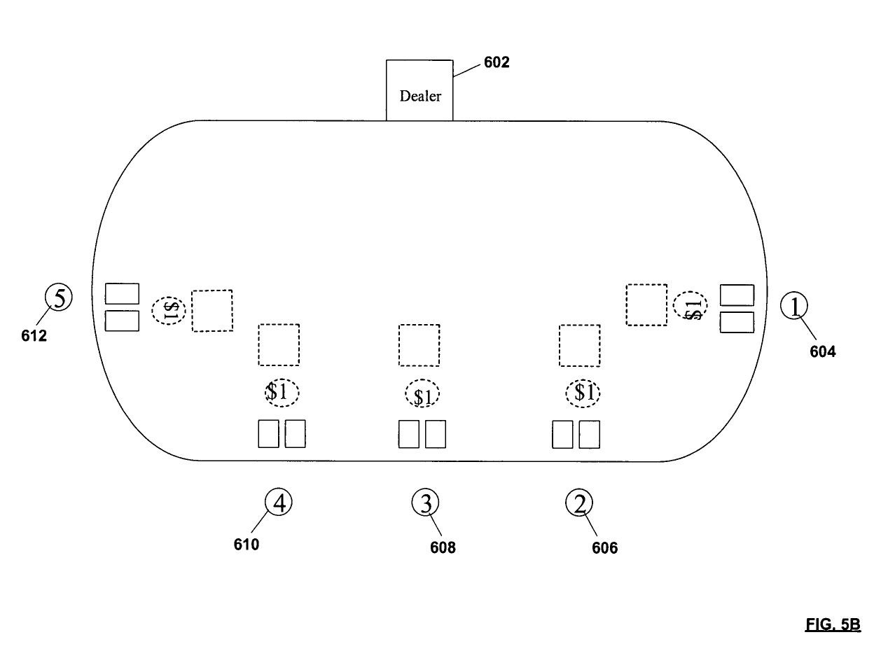

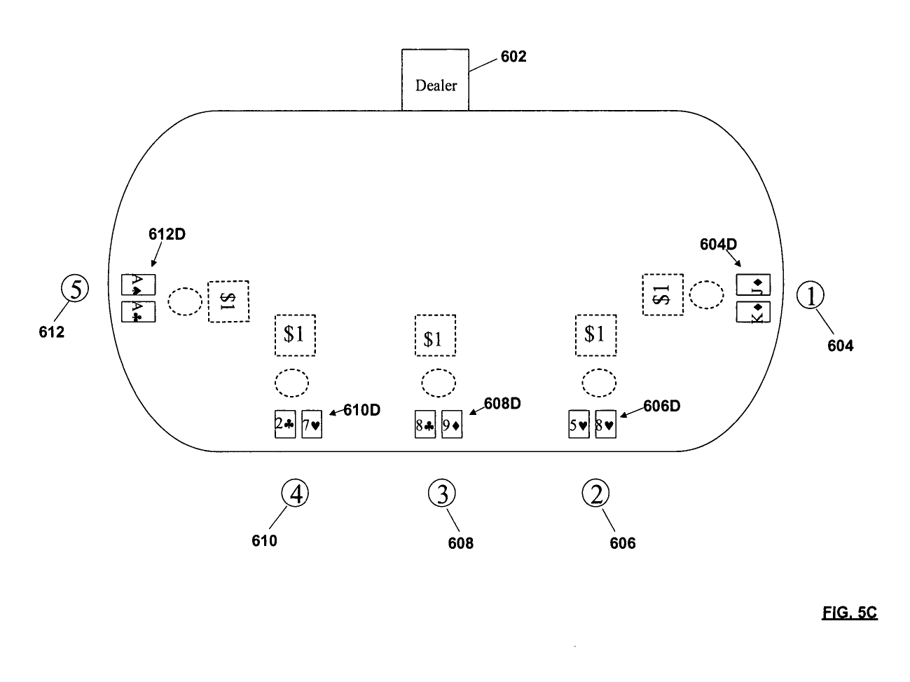

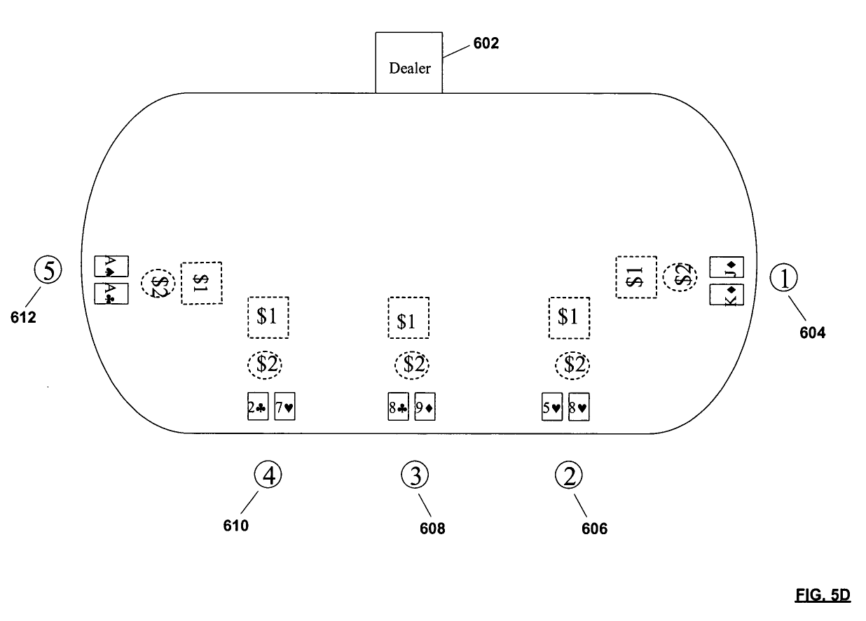

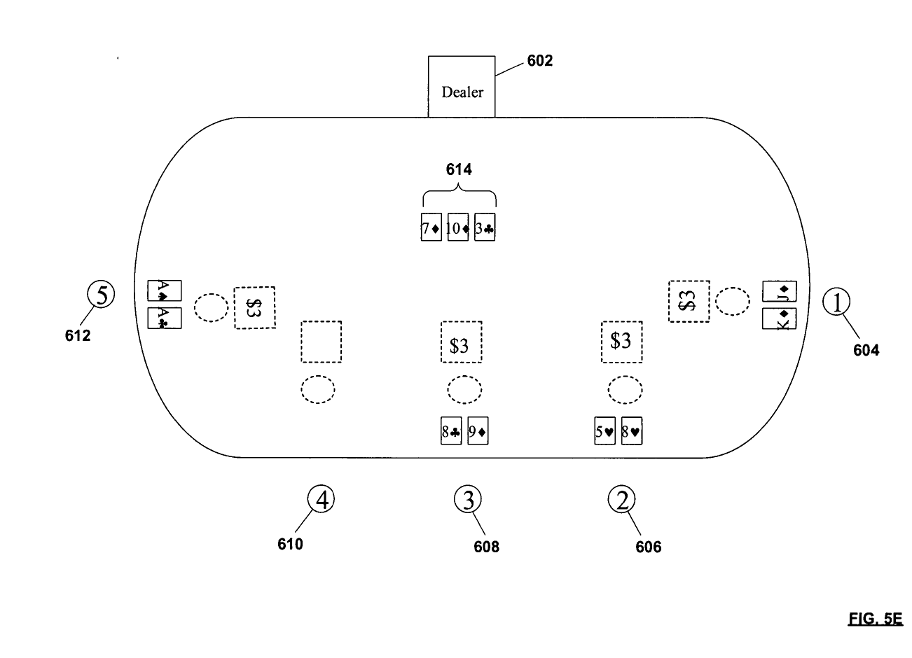

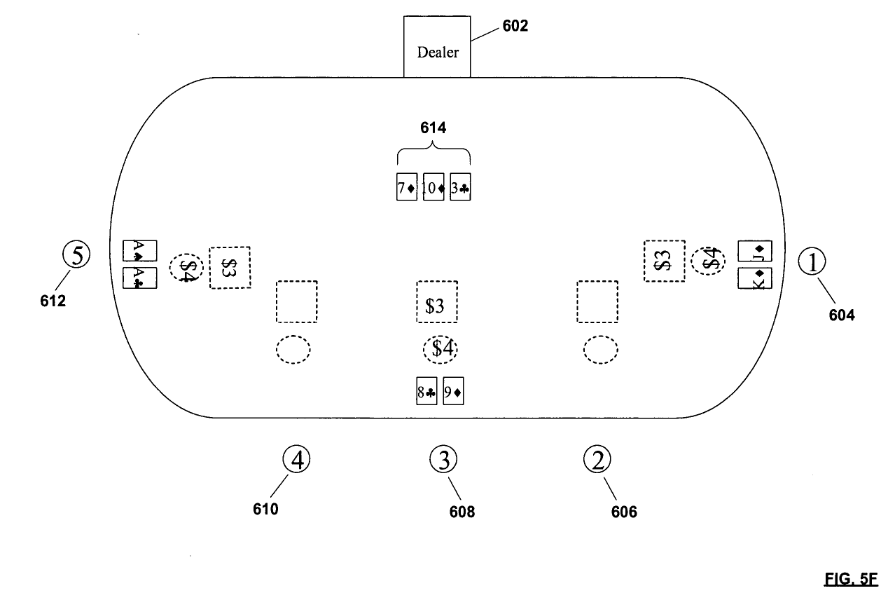

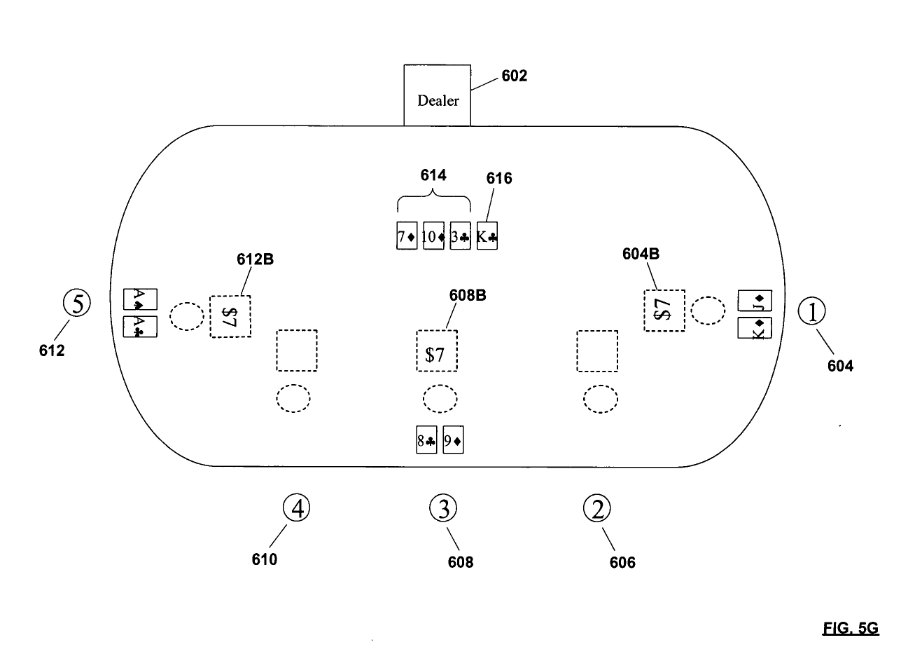

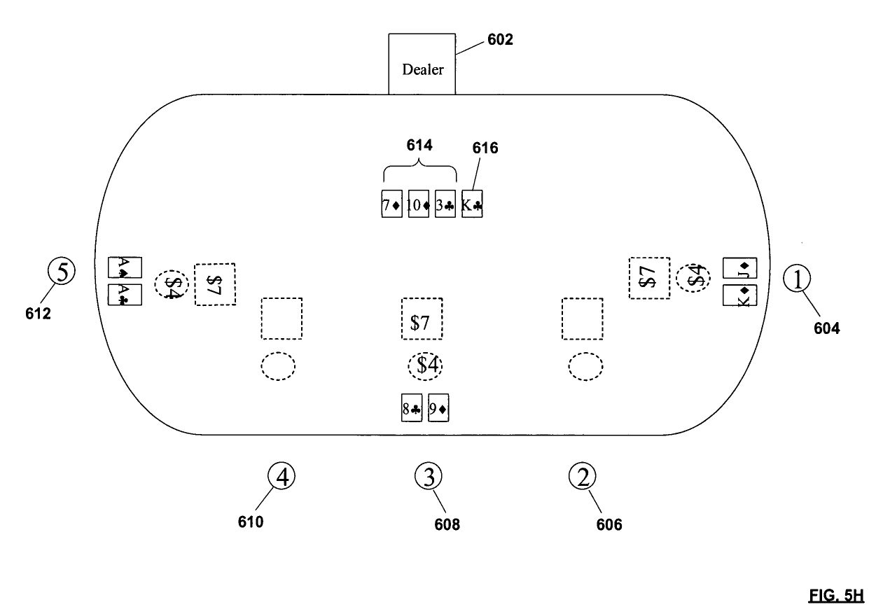

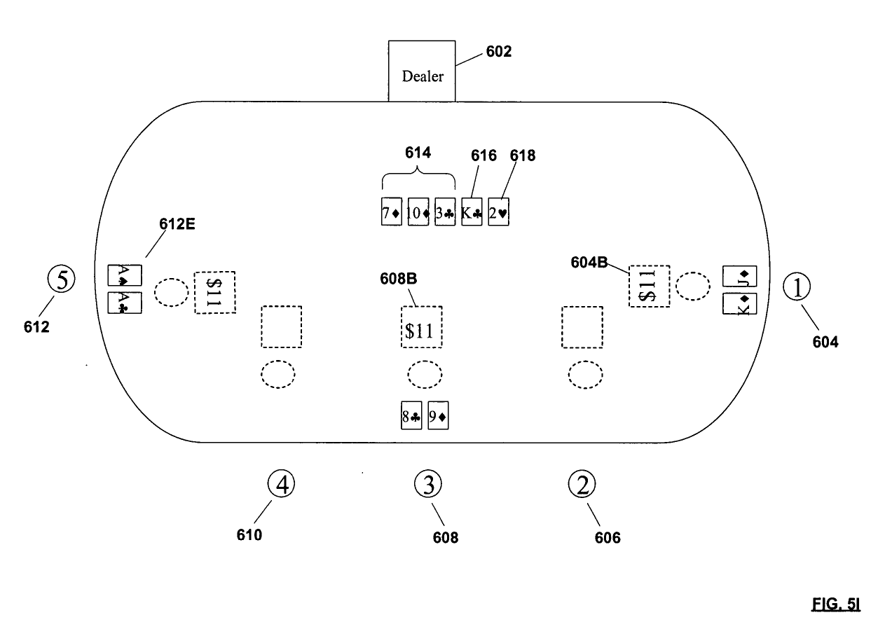

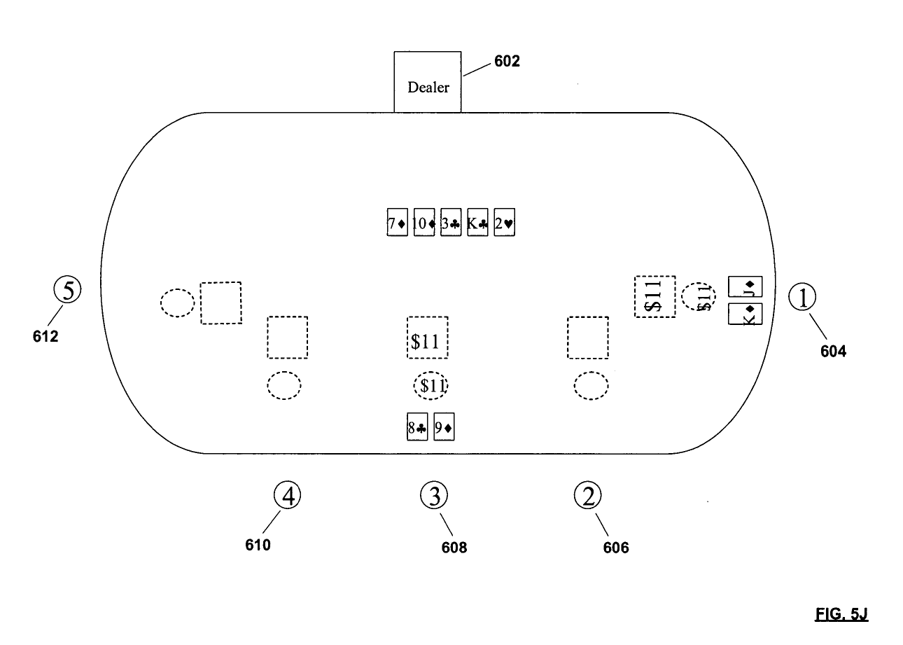

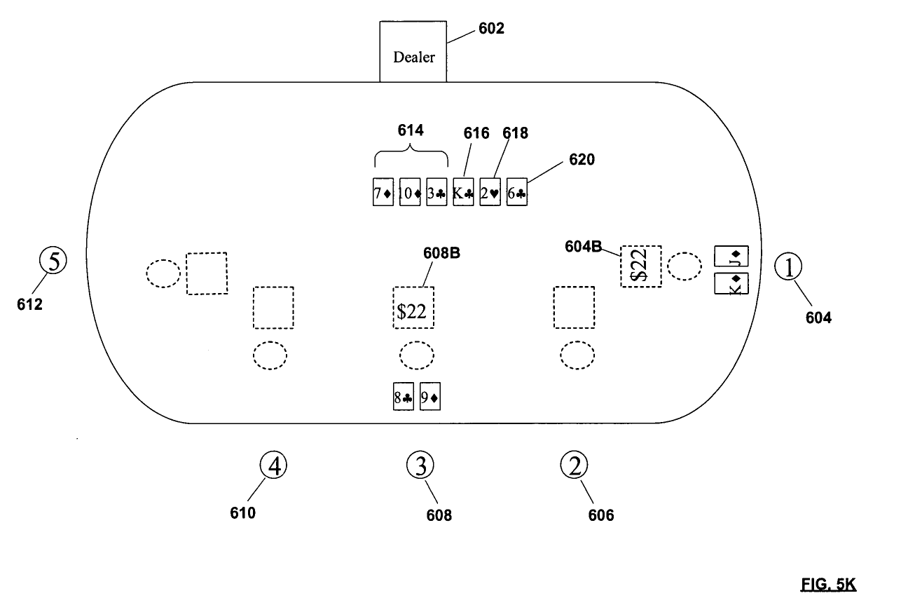

Referring now to FIGS. 5A through 5K, an example of a poker-style card game (i.e., Texas Hold 'Em) that may be played as a table game against a house (e.g., a casino or other card game sponsor) is illustrated in accordance with embodiments of the present invention.

As shown in FIG. 5A, a casino dealer 602 may deal cards to multiple players 604, 606, 608, 610, 612, pursuant to playing a round of Texas Hold 'Em poker. Each of the players 604, 606, 608, 610, 612 has an associated current bet area 604A, 606A, 608A, 610A, 612A (respectively) where a bet for a current round of betting may be placed; and an associated bet aggregation area 604B, 606B, 608B, 610B, 612B (respectively) where the aggregate amount bet on a particular hand may be moved by the dealer 602, for example. In addition, each of the players 604, 606, 608, 610, 612 has an associated card area 604C, 606C, 608C, 610C, 612C (respectively) where dealt cards may be placed.

For purposes of this example, it may be assumed that each of the players 604, 606, 608, 610, 612 must ante $1 (as shown in FIG. 5B) to receive initially dealt hands 604D, 606D, 608D, 610D, 612D of two cards each (as shown in FIG. 5C). In addition, a $2 bet is necessary to see the “flop” (i.e., the first three community cards), and a $4 bet is necessary for each of the “turn” card (i.e., fourth community card) and the “river” card (i.e., fifth community card). Also, each player 604, 606, 608, 610, 612 who desires an additional card at the normal ending point of the card game may be required to place a supplemental bet equal to the aggregate amount bet up to the normal ending point of the card game. Payouts may be made in accordance with the value associated with the hand achieved by each player 604, 606, 608, 610, 612. In the present example, payout amounts may awarded for a pair of jacks or better (with lower pairs having no associated payout), up to a royal flush with an associated payout of a multiple of the aggregate bet placed by the player. Two different payout schedules may be established: a first payout schedule may be applied to hands achieved on or before the normal ending point of the game (i.e., when a winner is declared once betting is completed after the “river” card is dealt); a second payout schedule may be applied to hands achieved in connection with additional cards dealt to one or more of the players 604, 606, 608, 610, 612, in accordance with embodiments of the present invention.

With reference to FIG. 5D, four of the players 604, 606, 608, 612, decide to bet the $2 necessary to see a flop; and one player 610 folds, whose initial ante of $1 and initial two cards are collected by the dealer 602. The dealer 602 then deals a flop 614, as shown in FIG. 5E, and another player 606 folds because he perceives his prospects for a heart flush to be improbable based on the flop 614. The remaining players 604, 608, 612, each place a $4 bet to allow them to see the next community card (i.e., the “turn” card), as shown in FIG. 5F.

Referring now to FIG. 5G, the dealer 602 transfers the $4 bets of the players 604, 608, 612 into their respective bet aggregation areas 604B, 608B, 612B. The dealer 602 also deals a “turn” card 616, which is added to the existing flop 614. Each of the remaining players 604, 608, 612, then place another $4 bet as shown in FIG. 5H to see the next community card, or “river” card.

Bets are collected by the dealer 602 as shown in FIG. 5I, and a “river” card 618 is dealt and added to the community hand. At this stage, one player 612 chooses to end play and collect a payout in accordance with the pair of aces achieved in his hand 612E; the dealer 602 collects the cards of this player 612 and awards him a payout in accordance with the first schedule (described above). As shown in FIG. 5J, the two remaining players 604, 608, each choose to place a supplemental bet of $11 (which corresponds to the current amount in the bet aggregation area 604B, 608B for each player 604, 608) for the ability to receive an additional community card and the opportunity to improve their payouts. One player 604 already has a hand that will provide a payout (i.e., a pair of kings), but the player 604 is hopeful to make a diamond flush with the additional card. The other player 608 does not presently have a hand that will award a payout, but the player 608 is hopeful that a straight can be achieved with the additional card.

With reference to FIG. 5K, the dealer 602 moves the $11 bets into the bet aggregation area 604B, 608B of each of the remaining players 604, 608. The dealer 602 then deals an additional card 620, which is added to the other community cards including the flop 614, the turn card 616, and the river card 618. One player 608 achieves a 6-10 straight and is awarded a payout in accordance with the second payout schedule (see above with respect to aspects of the examples set forth in FIGS. 5A-5K). The other player 604 did not improve his hand (a pair of kings) by factoring the additional card 620 into the hand. The player 604 receives a payout for the pair of kings in accordance with the first payout schedule (see above with respect to aspects of the examples set forth in FIGS. 5A-5K). It can be seen, however, that the payout awarded to the player 604 is essentially discounted by the supplemental $11 bet placed by the player 604 to receive the additional card 620, which did not yield an enhanced payout for the player 604.

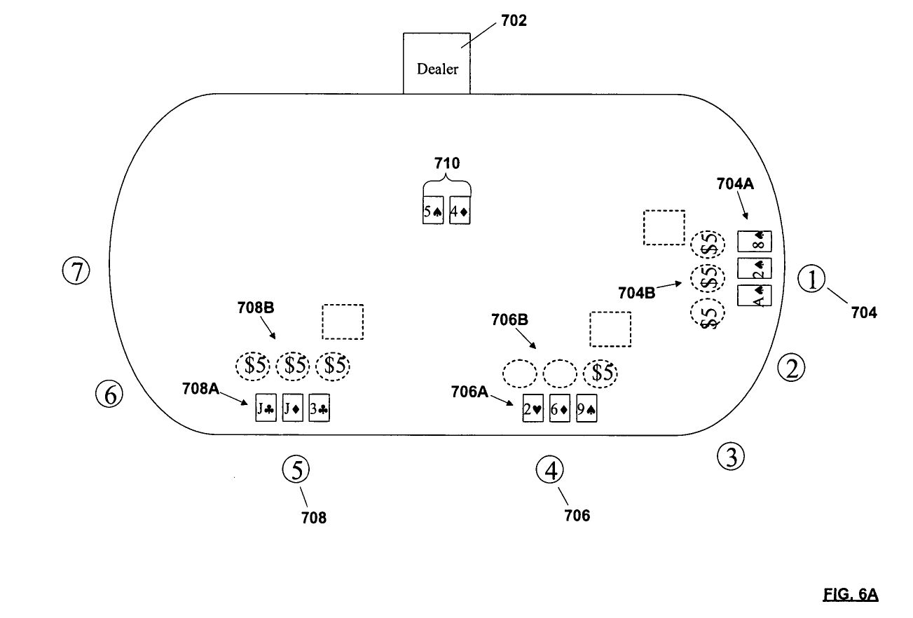

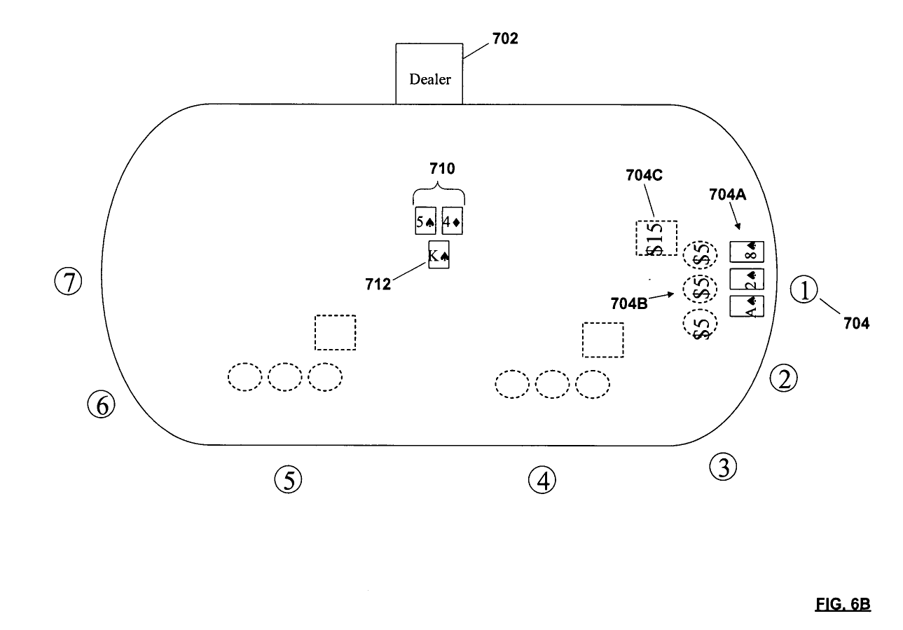

Referring now to FIGS. 6A and 6B, an example of a poker-style card game (i.e., “Let it Ride” poker) that may be played as a table game against a house (e.g., a casino or other card game sponsor) is illustrated in accordance with embodiments of the present invention. In this example, a casino dealer 702 has dealt cards to multiple players 704, 706, 708, pursuant to play at the normal ending point of a game of “Let it Ride” poker. Up to this point in the game, two players 704, 706 have not achieved hands 704A, 706A (respectively) that can be awarded a payout; the other player 708, however, has achieved a hand 708A including two jacks that will provide a payout. It can be seen that both player 704 and player 708 have let their $5 bets 704B, 708B (respectively) “ride”; in contrast, player 706 has let only one of his $5 bets 706B “ride” up to this stage of the game. In this example, one player 708 decides to collect a payout for his hand 708A (i.e., the two jacks); another player 706 decides to end or fold his hand 706A; and the remaining player 704 places a supplemental bet to be dealt an additional card for his hand 704A. It can be seen that the hands 704A, 706A, 708A achieved by each of the players 704, 706, 708 (respectively) take into account a community hand 710 that has been dealt during the course of playing the game.

As shown in FIG. 6B, an additional card 712 is dealt and added to the community hand 710 to make a new community hand. To receive the additional card 712, the player 704 has placed a supplemental bet 704C, which is equal to the total wager amount that the player 704 has “let ride” through the normal ending point of the game. The additional card 712 is a king (spades) and this completes a flush (spades) for the player 704. The player 704 then receives a payout in accordance with the flush achieved in the hand 704A.

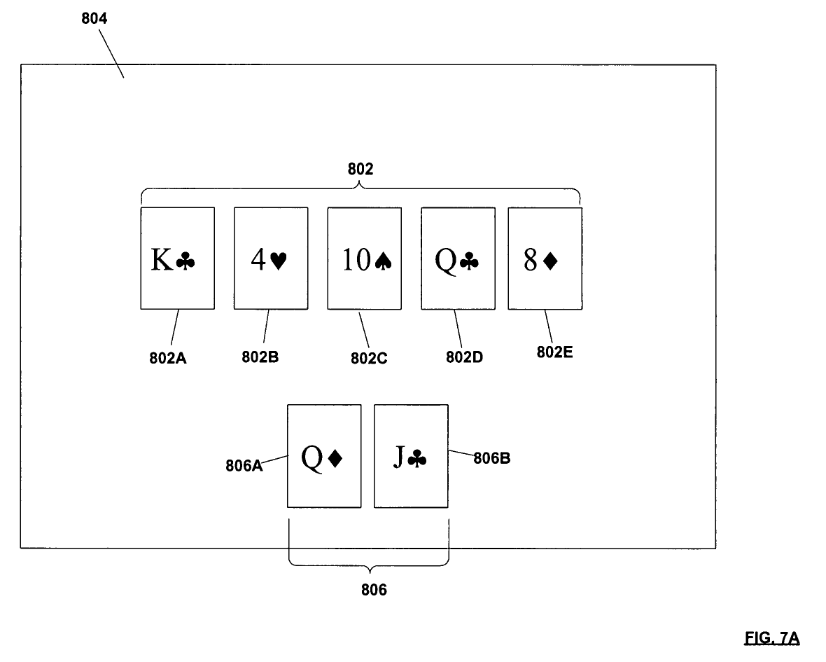

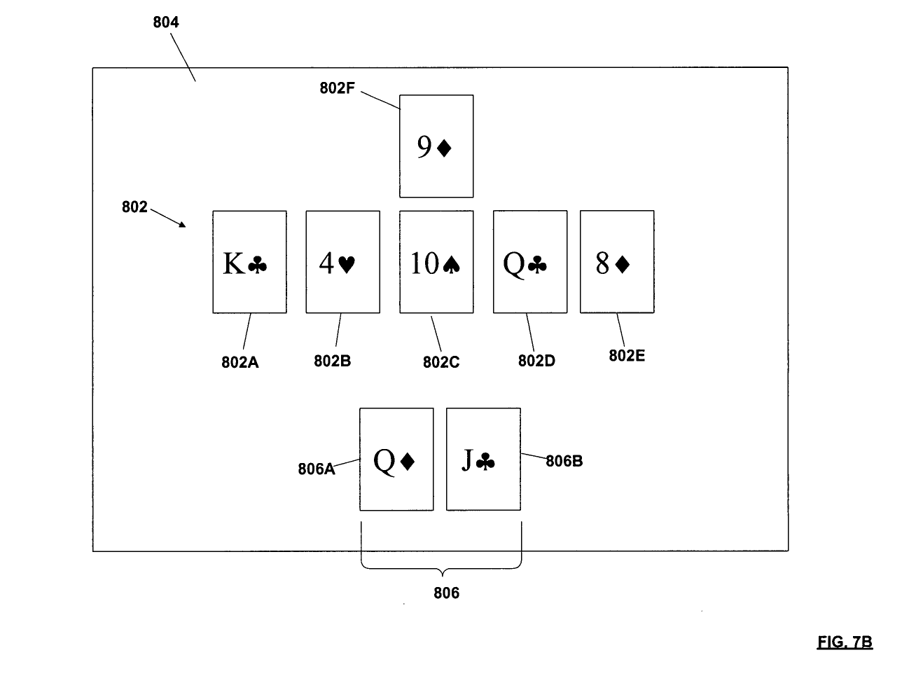

Referring now to FIGS. 7A and 7B, an example of a “Texas Hold 'Em” poker card game that may be played on a video gaming machine is illustrated in accordance with various embodiments of the present invention. For convenience of illustration, the card game is shown at a normal ending point of the game.

As shown in FIG. 7A, a community hand 802 has been dealt on a monitor 804 of the video gaming machine (not shown in its entirety). The community hand 802 includes a king (clubs) 802A, a four (hearts) 802B, a ten (spades) 802C, a queen (clubs) 802D, and an eight (diamonds) 802E. Through the course of the game, the player has been dealt a hand 806 including a queen (diamonds) 806A and a jack (clubs) 806B. It can be seen that, by factoring the cards in the community hand 802 into the hand 806, a pair of queens 802D, 806A has been achieved. At this stage, the player decides to attempt to improve the hand 806 by risking the payout on the pair of queens 802D, 806A, in exchange for the opportunity to achieve a straight.

As shown in FIG. 7B, an additional card 802F is dealt into the community hand 802. The additional card 802F is a nine (diamonds), which achieves a straight when factored into the hand 806. It can be appreciated that the hand 806 now provides an enhanced payout in comparison to the payout that would have been realized with just the pair of queens 802D, 806A.

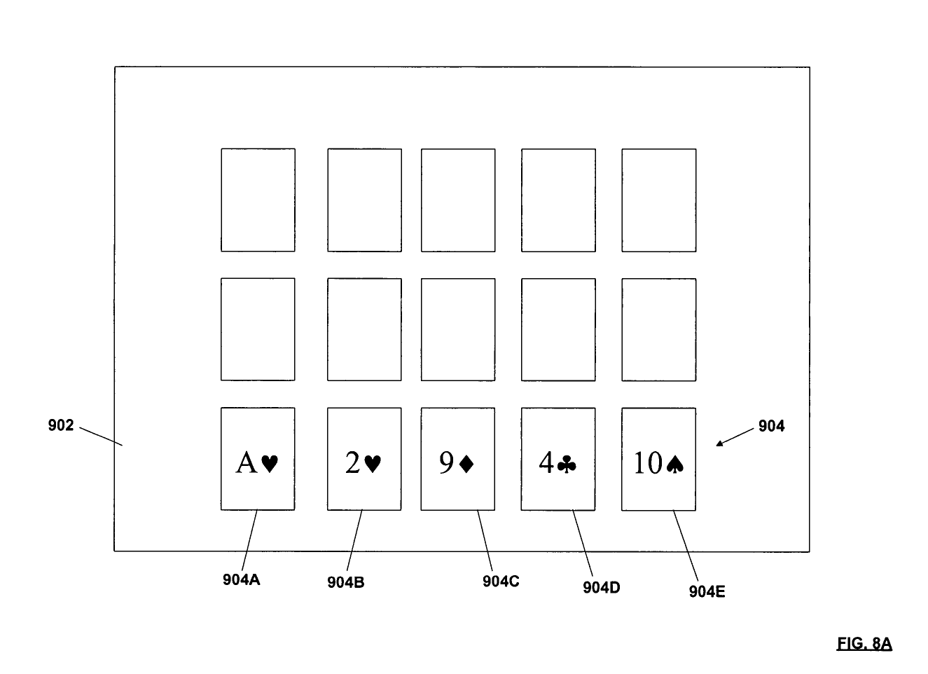

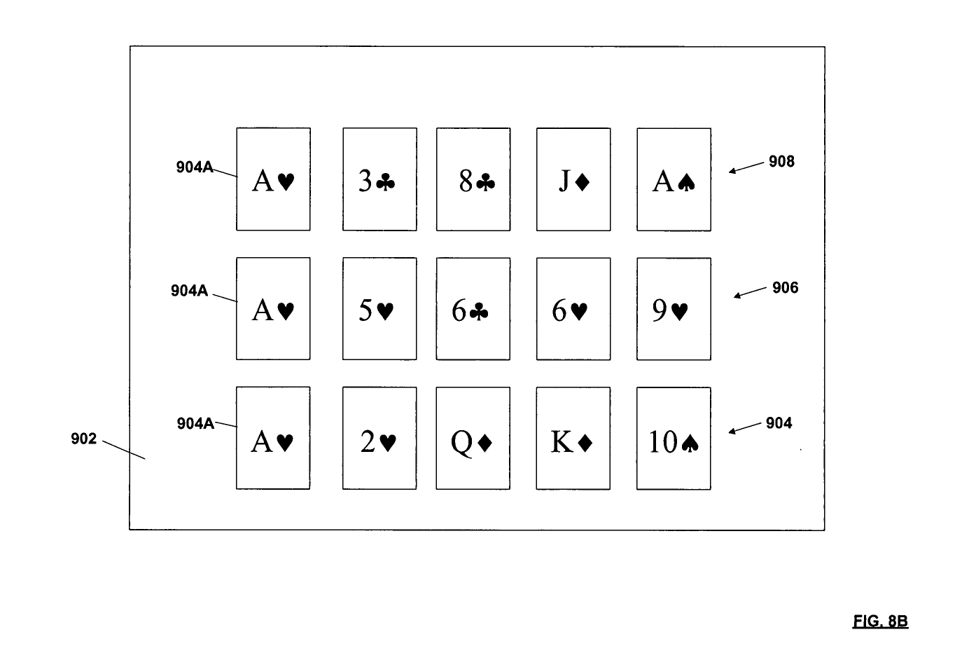

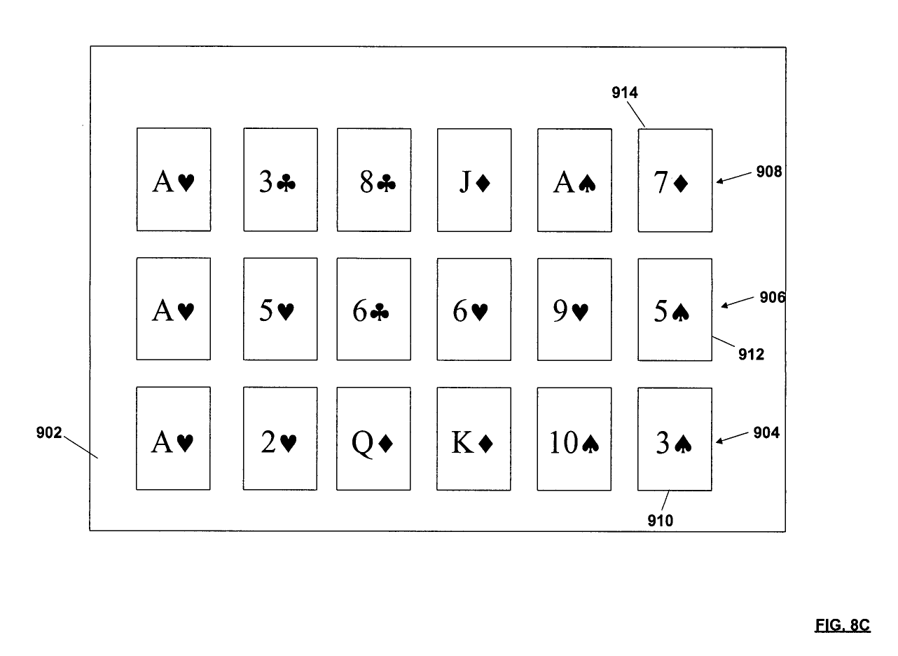

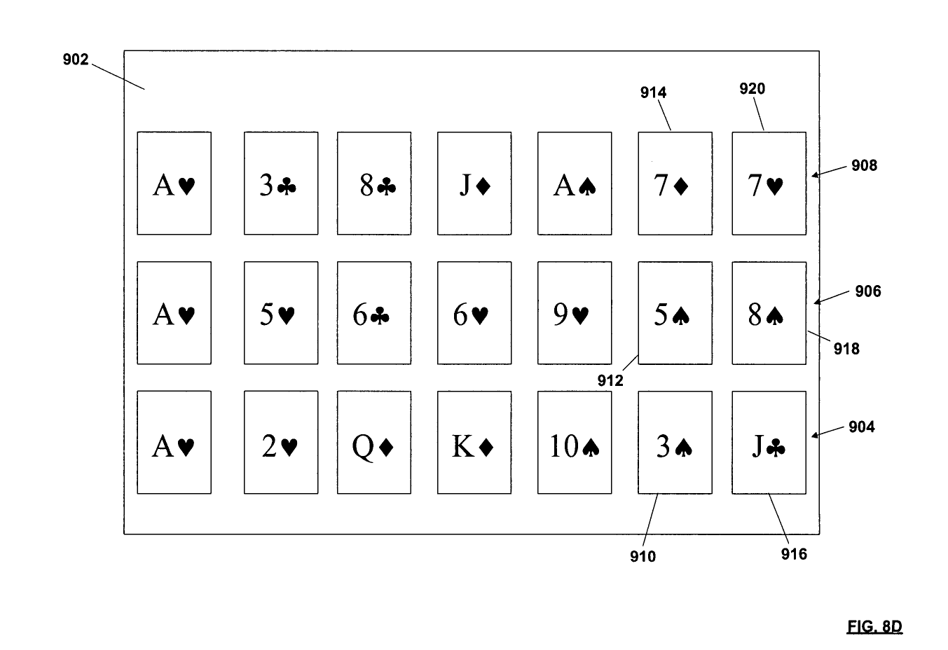

Referring now to FIGS. 8A-8D, an example of a “Triple Play” poker card game that may be played on a video gaming machine is illustrated in accordance with various embodiments of the present invention.

With reference to FIG. 8A, a monitor 902 is shown schematically for a video gaming machine configured for playing a “Triple Play” poker card game. An initial hand 904 is dealt which includes an ace (hearts) 904A, a two (hearts) 904B, a nine (diamonds) 904C, a four (clubs) 904D, and a ten (spades) 904E. The player elects to hold the ace 904A and discard the remaining cards in the hand 904.

As shown in FIG. 8B, two additional hands 906, 908 are dealt, resulting in a pair of sixes (i.e., a six (clubs) and a six (hearts)) in the second hand 906, and a pair of aces (i.e., the ace 904A and an ace (spades)) in the third hand 908. For purposes of this example, the game does not offer a payout for a hand as low as a pair of sixes, but the pair of aces achieved in the third hand 908 will provide a payout to the player.

In view of the possibilities for improving one or more of the hands 904, 906, 908, the player elects to place a supplemental bet and receive an additional card for each of the hands 904, 906, 908. As shown in FIG. 8C, an additional card 910 (three (spades)) is dealt for the first hand 904; an additional card 912 (five (spades)) is dealt for the second hand 906; and, an additional card 914 (seven (diamonds)) is dealt for the third hand 908. It can be seen that the additional cards 910, 912, 914 result in two pair (fives and sixes) for the second hand 906, in addition to the pair of aces in the third hand 908, as hands 906, 908 that will provide a payout to the player.

Next, in view of the possibilities for further improving one or more of the hands 904, 906, 908, the player elects to place another supplemental bet and receive a further additional card for each of the hands 904, 906, 908. As shown in FIG. 8D, a further additional card 916 jack (clubs)) is dealt for the first hand 904; a further additional card 918 (eight (spades)) is dealt for the second hand 906; and, a further additional card 920 (seven (hearts)) is dealt for the third hand 908. It can be seen that the additional cards 916, 918, 920 result in two pair (aces and sevens) for the third hand 908, in addition to a ten-ace straight in the first hand 904, as hands that will provide a payout to the player. The player has missed a heart flush, however, in the second hand 906.

Those skilled in the art will appreciate that embodiments of the present invention can be structured and practiced to leverage the drama and excitement that arises at the normal ending point of a poker-style card game. By extending play with an additional card, for example, the present invention enhances player enjoyment and increases opportunities for financial returns that may be realized by players and casino operators alike.

As used herein, a “computer” or “computer system” may be, for example and without limitation, either alone or in combination, a video gaming machine, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer-readable media. For example, a video gaming machine may include instructions stored on a computer-readable medium that can cause a computer or computer system to execute various aspects of the method embodiments described herein.

In general, computer-readable media may include any medium capable of being a carrier for an electronic signal representative of data stored, communicated or processed in accordance with embodiments of the present invention. Where applicable, method steps described herein may be embodied or executed as instructions stored on a computer-readable medium or media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the following claims.

What is claimed is:

1. A computer-readable medium including instructions for causing a computer system to execute a method for playing a card game, the medium comprising:
instructions for permitting placement of a supplemental bet in association with a poker-style card game;
instructions for dealing at least one additional card at a normal ending point of the poker-style card game in response to placement of the supplemental bet; and,
instructions for factoring the additional card into the outcome of the poker-style card game.

2. The computer-readable medium of claim 1, further comprising instructions for awarding a payout in accordance with the impact of the additional card on the outcome of the poker-style card game.

3. The computer-readable medium of claim 1, further comprising instructions for collecting the supplemental bet in accordance with the impact of the additional card on the outcome of the poker-style card game.

4. The computer-readable medium of claim 1, further comprising instructions for awarding at least one of:
(i) a payout at the normal ending point of the poker-style card game; and,
(ii) a payout in accordance with the supplemental bet and the additional card.

5. The computer-readable medium of claim 1, further comprising instructions for collecting at least one of:
(i) at least one bet placed during play of the poker-style card game; and,
(ii) the supplemental bet.

6. The computer-readable medium of claim 1, wherein the computer system includes a video gaming machine.

7. The computer-readable medium of claim 1, further comprising:
instructions for dealing at least one further additional card after the normal ending point of the poker-style card game; and,
instructions for factoring the further additional card into the outcome of the poker-style card game.

8. The computer-readable medium of claim 7, further comprising instructions for permitting placement of an additional supplemental bet in association with the poker-style card game and instructions for dealing the further additional card in association with the additional supplemental bet.

9. A method for playing a card game, the method comprising:
permitting placement of a supplemental bet in association with a poker-style card game;
dealing at least one additional card at a normal ending point of the poker-style card game in response to placement of the supplemental bet; and,
factoring the additional card into the outcome of the poker-style card game.

10. The method of claim 9, further comprising awarding a payout in accordance with the impact of the additional card on the outcome of the poker-style card game.

11. The method of claim 9, further comprising collecting the supplemental bet in accordance with the impact of the additional card on the outcome of the poker-style card game.

12. The method of claim 9, further comprising awarding at least one of:
(i) a payout at the normal ending point of the poker-style card game; and,
(ii) a payout in accordance with placement of the supplemental bet and the additional card.

13. The method of claim 9, further comprising collecting at least one of:
(i) at least one bet placed during play of the poker-style card game; and,
(ii) the supplemental bet.

14. The method of claim 9, further comprising:
dealing at least one further additional card after the normal ending point of the poker-style card game; and,
factoring the further additional card into the outcome of the poker-style card game.

15. The method of claim 14, further comprising permitting placement of an additional supplemental bet in association with the poker-style card game and dealing the further additional card in association with the additional supplemental bet.

16. A computer-readable medium including instructions for causing a computer system to execute a method for playing a card game, the medium comprising:
instructions for dealing at least one additional card at a normal ending point of the poker-style card game; and,
instructions for factoring the additional card into the outcome of the poker-style card game.

17. A method for playing a card game, the method comprising:
dealing at least one additional card at a normal ending point of a poker-style card game; and,
factoring the additional card into the outcome of the poker-style card game.
